(19) United States
(12) Patent Application Publication
(10) Pub. No.: US 2026/0126030 A1
(43) Pub. Date: May 7, 2026

(54) DRIVE TRAIN ASSEMBLY FOR DRIVING A WORKING UNIT WITH FLUCTUATING LOAD

(71) Applicant: Liebherr-Components Biberach GmbH, Biberch an der Riss (DE)

(72) Inventors: David FÜHRLE, Mietingen (DE); Viktor SCHINDLER, Uttenweiler (DE); Stefan BINDER, Neu-Ulm (DE); Norbert HAUSLADEN, Biberach (DE)

(73) Assignee: Liebherr-Components Biberach GmbH, Biberch an der Riss (DE)

(21) Appl. No.: 19/406,756

(22) Filed: Dec. 2, 2025

Related U.S. Application Data
(63) Continuation of application No. PCT/EP2024/064650, filed on May 28, 2024.

(30) Foreign Application Priority Data
Jun. 2, 2023 (DE) 102023114540.1

(51) Int. Cl. F03G 3/08; A01F 15/04; A01F 15/08; F16H 37/12

(52) U.S. Cl. CPC F03G 3/08; A01F 15/0841; F16H 37/124; A01F 15/04

(57) ABSTRACT

The present invention relates to a drive train assembly for driving a working unit with fluctuating power consumption from a drive source, with a unit transmission which converts a driving movement of the drive source into a working movement of the work unit and is connected by a transmission output element to the working unit and is connected by a transmission input element to the drive source, and with a flywheel accumulator for mitigating load impacts and/or power consumption fluctuations, wherein the flywheel accumulator is connected on the output side of the unit transmission to the drive train which runs from the unit transmission to the working unit.

### CROSS-REFERENCE TO RELATED APPLICATIONS

This application is a continuation of International Patent Application Number PCT/EP2024/064650 filed May 28, 2024, which claims priority to German Patent Application Number DE 10 2023 114 540.1 filed Jun. 2, 2023, which are incorporated herein by reference in their entireties.

### BACKGROUND

The present invention relates generally to working machines with working units which are subject to fluctuating loads or have a fluctuating power consumption. The invention relates on the one hand to a drive train assembly for driving such a working unit with fluctuating power consumption from a drive source, with a unit transmission which converts a driving movement of the drive source into a working movement of the working unit and is connected with a transmission output element to the working unit on the one hand and is connected with a transmission input element to the drive source on the other hand, and with a flywheel accumulator for mitigating load impacts or fluctuations. On the other hand, the invention relates to a working machine comprising a drive unit with fluctuating power consumption and the drive train assembly with the unit transmission and the flywheel accumulator.

Various working units sometimes experience such strong fluctuations in the load or power consumption that the drive source experiences a significant change in speed and results in overall jerky operation of the working machine, as the drive source itself cannot easily absorb or compensate for corresponding torque surges. For example, various agricultural working units exhibit such major load or power consumption fluctuations, which can be caused by the mechanical design or operation of the working unit itself or by fluctuating external loads.

For example, rectangular balers, in which a tamper is periodically pressed into a bale chamber in order to press the crop into rectangular bales, show such fluctuations in power consumption caused by the mode of operation. Similar fluctuations in power consumption caused by fluctuating external loads are also seen in the chopping drums of forage harvesters or threshing devices of a combine harvester, or in the cutting unit of a round baler when the crop being fed fluctuates more strongly.

Similar fluctuations in power consumption are also known in production technology for path-bound presses whose press plunger is driven by a crank gear.

If such working units of agricultural machinery are driven from a tractor via a power take-off shaft, fluctuations in the speed of the tractor's drive motor induced by the power input fluctuations of the working unit not only lead to uneven operation of the working unit itself, but also to jerky driving operation of the tractor, as the tractor's drive motor serves not only as a power take-off shaft drive, but also as a traction drive. In the case of the rectangular balers in question, this can cause the tractor to buckle with every ram stroke of the baler, which is not only unpleasant for the driver, but can also lead to increased wear on the components and affect the service life of the engine.

Various measures have already been considered to mitigate the effects of load or power consumption fluctuations of the working unit on the drive motor. For example, EP 3 298 872 B1 proposes a control system that detects or anticipates fluctuations in the power consumption of the working unit. The speed changes of the drive motor are compensated for in order to ultimately achieve a constant driving speed of the tractor. This solution does not even attempt to prevent or mitigate the speed fluctuations of the drive engine due to the fluctuating power consumption of the working unit, but rather to compensate for the effect of the speed fluctuations of the drive engine by intelligently controlling the diesel engine.

Another approach is to provide a flywheel accumulator in the drive train that drives the working unit, the kinetic energy of which mitigates the load or power consumption fluctuations of the working unit or their consequences. For example, such a flywheel accumulator in the drive train of a rectangular baler can smooth out the high energy required at certain points or cyclically when pushing the tamper into the bale chamber in order to reduce the impact on the tractor and avoid pitching movements or a jerky driving speed.

However, in order to achieve the best possible smoothing of the punctual or cyclical energy fluctuations, it is necessary for the flywheel accumulator to be able to provide a sufficiently high kinetic energy. To achieve this, it would be simple to increase the flywheel accumulator's flywheel mass, although this measure is subject to various limitations. On the one hand, the flywheel mass itself cannot be increased arbitrarily, as the available installation space is usually limited and the construction weight must also be taken into account.

In this respect, on the other hand, it has already been considered to increase the kinetic energy of the flywheel accumulator by increasing its speed, as the kinetic energy of the flywheel accumulator depends on its angular velocity. More precisely, the angular velocity is included in the kinetic energy as the square of the formula Ekin=1/2*Jo*ω2, where Jo is the mass moment of inertia and ω the angular velocity.

On the other hand, such an increase in the kinetic energy of the flywheel accumulator is also limited by the fact that the drive source, for example in the form of the tractor's drive engine, cannot provide the necessary torque to drive up the flywheel accumulator. To counter this problem, a slipping clutch is sometimes used, which is connected upstream of the flywheel mass in order to gradually introduce the available drive power into the flywheel mass, which extends the run-up time of the flywheel accumulator accordingly. The flywheel mass is thus gradually brought up to the desired operating speed so that the drive motor is not stalled. However, such a slipping clutch must be sufficiently dimensioned to be able to absorb the energy generated during the slipping time, which is not easily possible in confined installation or ambient conditions.

Another approach to solving these run-up problems is to operate the flywheel accumulator via a planetary gear with a variable transmission ratio in order to be able to adjust the speed of the flywheel accumulator depending on the operating situation and gradually increase it when the machine train is run up by adjusting the transmission ratio, cf. for example DE 10 2021 116 061 A1.

Even if the ramp-up problem can be alleviated with these various approaches and a sufficiently high flywheel mass or sufficiently high kinetic energy of the flywheel accumulator can be provided to smooth out the load peaks, previous solutions result in heavy, shock loads on the transmission elements of the unit transmission in the area of the unit transmission. The high kinetic energy of the flywheel accumulator on the one hand and the shock load from the working unit on the other place a correspondingly high load on the unit transmission in such previous solutions, if the flywheel accumulator with its high kinetic energy intercepts the load impact of the working unit, so to speak, and keeps it away from the drive source.

Such unit transmissions often have a bevel gear stage in order to generate or bridge an angular offset between the transmission input shaft and the transmission output shaft and, if necessary, to achieve a desired transmission ratio, wherein the desired speed difference between the transmission input shaft and the transmission output shaft can also be achieved by further transmission elements, for example in the form of meshing spur gear pairs, planetary stages, further bevel gear stages or chain or belt stages. These gearbox elements are subject to heavy loads and suffer heavy wear due to torque or load impacts, or they must be dimensioned massively in order to be able to withstand the loads permanently, which leads to a rather high gearbox weight and corresponding size.

In some working units, the load impacts only occur in a small angle of rotation range and often always in the same angle of rotation range and thus on the same teeth of the gearing. For example, ram presses work with a connecting rod that is hinged to a crank that is attached to the transmission output element. The press ram always experiences the load impact towards the top dead center of the crank rotation, so that the load impacts are always transferred via the same pairs of teeth. Similar load shocks in only small angular ranges can also occur in threshing drives or other reciprocating working units.

Based on this, the present invention is based on the task of creating an improved drive train assembly of said type and an improved working machine with such a drive train assembly, which avoid the disadvantages of the prior art and further develop the latter in an advantageous manner. In particular, the flywheel accumulator should be able to provide sufficient energy to smooth out the power consumption fluctuations of the working unit in a limited installation space without overloading the unit transmission or requiring a massive, large design of the working transmission, even if very short load impacts occur in the same transmission position.

### SUMMARY

According to the invention, said task is solved by a drive train assembly according to claim 1 and a working machine according to claim 15. Preferred embodiments of the invention are the subject of the dependent claims.

It is therefore proposed to connect the flywheel accumulator on the output side or the transmission output side of the unit transmission so that load impacts from the working unit can be introduced into the flywheel accumulator or compensated by the flywheel accumulator without having to transmit the load impacts through the unit transmission. Due to the connection of the flywheel accumulator on the output side, the load impacts branch off, so to speak, before reaching the unit transmission or already at the transmission output side and leave the gear stages of the unit transmission, such as any bevel gear stage or intermediate pinion stages that may be present, unloaded. essentially only the power coming from the drive shaft is transmitted by the unit transmission, while the high load impacts from the working unit are essentially directed past the unit transmission into the flywheel accumulator or compensated for by it.

According to the invention, the flywheel accumulator is connected on the output side of the unit transmission to the drive train that goes from the unit transmission to the working unit. The flywheel accumulator or a connecting element that drives the flywheel accumulator is in engagement with a drive train element that is arranged on the output side of the unit transmission or is directly coupled to the drive train that leads from the unit transmission to the working unit. By connecting the flywheel accumulator on the transmission output side, the kinetic energy of the flywheel accumulator can be conducted past the unit transmission or past the gear stages of the unit transmission directly into the working unit.

In particular, the flywheel accumulator or the connecting element of the drive train leading to the flywheel accumulator that drives the flywheel accumulator can be in direct engagement with said transmission output element, to which the working unit is also connected at the same time.

Said transmission output element can be a gear wheel which transmits its speed to the working unit or to the drive train leading to the working unit on the one hand and to the flywheel accumulator or to the drive train going to the flywheel accumulator on the other. The flywheel accumulator and the working unit are thus connected to the same gear wheel and connected to the same output speed of the gear wheel, wherein the flywheel accumulator and working unit nonetheless do not have to operate at the same speed or frequency, as there may be a further gear stage in the drive train to the flywheel accumulator, for example, in order to increase the speed of the flywheel accumulator and generate a correspondingly high kinetic energy.

In particular, said transmission output element of the unit transmission can drive a crank leading to the working unit or drive a crank which drives the working tool of the working unit via a connecting rod, for example the tamping piston of an agricultural harvester or the press ram of a path-bound press in forming technology.

A connecting element for connecting the flywheel accumulator can be engaged with said crank wheel, i.e. the gear wheel acting as the transmission output element which drives said crank.

In order to prevent the intermittent loads from the working unit or the intermittently pulsating power flow between the working unit and the shrinkage wheel accumulator from passing through the gear stages of the unit transmission, two separate drive trains are brought together or branched off on the transmission output side in a further development of the invention. On the one hand, the drive train that leads through the unit transmission to the drive source, for example the power take-off shaft or the drive motor of the tractor, is started up to said transmission output element. On the other hand, the separate drive train that leads to the flywheel accumulator is connected to said transmission output element. As said additional second drive train to the flywheel accumulator is attached to the transmission output of the unit transmission, the corresponding peak torques are not transmitted via the entire unit transmission, but branch off from the working unit on the transmission output side towards the flywheel accumulator.

Said both first and second drive trains or their connecting elements can each be in face-to-face engagement with the transmission output element designed as a gear wheel, wherein said connecting elements of the two drive trains can be arranged in different sectors, for example on opposite sides or in adjacent sectors, of the gear wheel. Depending on the configuration of the unit transmission, however, not both or even none of the connecting elements of the two drive trains need to be in face-to-face engagement with the gear wheel. For example, both drive trains could also be in engagement with said gear wheel via a bevel gear in each case, wherein the connecting elements could be arranged on the same side of the gear wheel if the two connecting elements are arranged in different sectors. Conversely, however, it would also be possible to arrange such bevel gears on opposite sides of the common gear wheel serving as transmission output element, in which case the connecting elements of the two drive trains could also be assigned to the same sector or section of the gear wheel.

Other forms of engagement or mixed forms, such as cone engagement on the one hand and face-to-face engagement on the other, would be conceivable. However, said design with drive trains in face-to-face engagement is advantageous in terms of a compact design and a simple configuration of the gear wheel acting as a transmission output element.

In particular, the two drive trains or their connecting elements can be in meshing engagement with said gear wheel.

In an advantageous further development of the invention, the two drive trains mentioned, which on the one hand lead to the flywheel accumulator and on the other hand lead through the unit transmission to the drive source, can each have at least one or more gear stages, in particular several transmission and/or reduction stages for changing the speed.

In particular, the flywheel accumulator can be connected to said transmission output element via at least one transmission gear stage, so that the flywheel accumulator runs at a higher speed than said transmission output element.

For example, said transmission gear stage can comprise a planetary gear, which can be configured as a single-stage or multi-stage gear. With such a transmission gear stage, the flywheel accumulator can be operated at a possibly significantly increased speed in order to achieve a high kinetic energy for sufficient smoothing of the torque or load impacts of the working unit.

In order to be able to start up the flywheel accumulator even with only a limited torque supply from the drive source, in particular also to high flywheel speeds as intended, a starting aid for starting up the flywheel accumulator can be provided in a further development of the invention. In a further development of the invention, such a starting aid can comprise an engine to support the starting up, for example a hydraulic motor or, in particular, an electric motor.

Such a start-up auxiliary motor can advantageously be assigned directly to the drive train of the flywheel accumulator and/or be provided on the output side of the unit transmission so that the drive torque of the start-up motor does not have to be transmitted via the unit transmission in order to start up the flywheel accumulator.

Preferably, said start-up motor is connected to the gear stage by means of which the output or output speed of the unit transmission is translated into a higher flywheel speed. For example, the start-up motor can be assigned to said planetary gear, which can be provided in the second, separate drive train for the flywheel accumulator.

Depending on the configuration of the starting engine, a motor for relatively low torques and high speeds can be provided, wherein such an engine can be connected, for example, to the sun gear of the planetary gear or a sun gear shaft.

Alternatively, a starting engine with a relatively high torque and lower speeds can also be used, wherein such an engine can preferably be connected to the planet carrier or the ring gear of said planetary gear. A connection to an intermediate wheel is also possible if this is advantageous for favorable space conditions or accessibility.

Preferably, the starting aid is configured in such a manner that the start-up motor is only active or in operation when the flywheel accumulator is raised. Advantageously, an overrunning freewheel can be provided so that the start-up motor can be switched off after the flywheel accumulator has been raised.

An overrunning freewheel provided between the engine and the flywheel accumulator is torque-transmitting in one direction of rotation and freewheeling in the opposite direction of rotation, so that the engine can entrain the flywheel accumulator during startup, while the engine can be switched off without being entrained by the flywheel accumulator when the flywheel accumulator is started up.

As an alternative or in addition to an engine starting aid, a switchable gear, for example a switchable planetary gear, can also be provided as a starting aid. A switchable gear of this type can be used to start up the flywheel accumulator with an initially low transmission ratio or possibly also with a reduction ratio and the gear can then be shifted up in one or more stages or even continuously in order to increase the transmission ratio and achieve an increasingly higher flywheel accumulator speed with a limited input speed.

In order to avoid damage to the drive train or the working unit in the event of a blockage occurring during operation that is no longer intended, for example if the working tool is blocked by stones or other obstacles, a safety slip clutch can be provided in an advantageous further development of the invention, which allows the flywheel accumulator to slip in relation to the working tool or the drive train leading to it if an intended torque or load value in the drive train is reached or exceeded. the drive train leading to it, if an intended torque or load value in the drive train is reached or exceeded. Such an intended release value of the safety slipping clutch can advantageously be dimensioned so large that in intended operation, in which the fluctuating power consumption at the working unit occurs as intended, for example the load impacts of a press described above, the safety slipping clutch remains closed or does not slip in order to smooth out the intended load fluctuations of the working unit. If, on the other hand, exceptional load impacts occur, for example as a result of a blockage in the drive train, so that the torque or load in the drive train exceeds the trigger threshold value of the safety slipping clutch, the safety slipping clutch slips and thus limits the torque occurring in the drive train or that can be transmitted to the safety slipping clutch.

Such a safety slipping clutch can advantageously be provided in the flywheel accumulator drive train in the immediate vicinity of the flywheel accumulator. If said flywheel accumulator drive train has a planetary gear in said manner, the safety slipping clutch can be provided, for example, on the sun gear or the sun gear shaft, which transmits relatively smaller torques. Alternatively, the safety slipping clutch can also be connected to the planet carrier or the ring gear of the planetary gear, which usually have lower speeds. For reasons of accessibility or limited space, for example, the safety clutch can also be provided on any intermediate wheel of the flywheel accumulator drive train.

Advantageously, said safety slipping clutch is provided in the flywheel accumulator drive train, in particular between the transmission output wheel of the unit transmission and said flywheel accumulator.

### BRIEF DESCRIPTION OF THE DRAWINGS

The invention is explained in more detail below with reference to preferred embodiments and the corresponding drawings. The drawings show:

FIG. 1: a side view of a working machine with a drive train assembly according to an advantageous embodiment of the invention, wherein the working machine is configured as an agricultural baler, the working unit of which can be driven by the power take-off shaft of a tractor via a cardan shaft;

FIG. 2: a schematic representation of the drive train assembly of the working machine from FIG. 1, showing the unit transmission for driving the working tool of the working machine and the flywheel accumulator connected on the output side via a separate drive train, the flywheel accumulator being connected via a two-stage planetary gear;

FIG. 3: a schematic representation of the drive train of the working machine of FIG. 1 according to a further embodiment of the invention, according to which the flywheel accumulator connected on the output side of the unit transmission is connected via a single-stage planetary gear and an intermediate spur gear stage,

FIG. 4: a schematic representation of the drive train assembly of the working machine of FIG. 1 according to a further advantageous embodiment of the invention, according to which the flywheel accumulator connected on the output side of the unit transmission is connected via a planetary gear and an intermediate gear stage, an auxiliary drive for raising the flywheel accumulator being connected to the planetary gear via a spur gear stage;

FIG. 5: a side view of the unit transmission of the working machine from FIG. 1, showing the arrangement of the flywheel accumulator relative to the unit transmission;

FIG. 6: a schematic representation of the power flows during operation of the drive train assembly according to the embodiment example of FIG. 3, wherein the power flow at the highest torque peak is shown, at which a high power flow occurs from the flywheel accumulator to the transmission output wheel of the unit transmission and a low power flow occurs from the drive source into the unit transmission;

FIG. 7: a representation of the power flows in the drive train assembly according to FIG. 3 during normal operation, in which energy is supplied from the drive source to the flywheel accumulator with simultaneous output of power via the transmission output wheel to the working unit; and

FIG. 8: a representation of the power flows of the drive train assembly according to FIG. 3 during the starting process of the flywheel accumulator, in which the flywheel accumulator is started up by the start-up motor and the drive train, which leads from the unit transmission to the drive source, is also rotated without torque.

### DETAILED DESCRIPTION

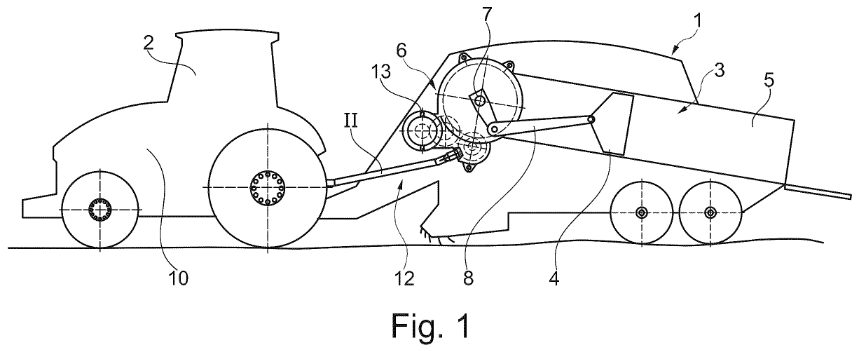

As shown in FIG. 1, the working machine 1 can be configured as an agricultural machine for processing harvested crops or possibly also for soil cultivation, in particular in the form of an attachment device for attachment to a tractor 2.

The working machine 1 comprises at least one working unit 3, which can be subjected to cyclically strongly fluctuating loads during operation and/or can exhibit cyclically strongly fluctuating power consumption. As shown in FIG. 1, the working machine 1 can be configured in particular as a baler, the working unit 3 of which can comprise a tamper 4 which moves into a bale forming chamber 5 or is cyclically moved back and forth therein in order to press harvested crops picked up from the ground, which have been conveyed into the bale forming chamber 5 via a suitable conveyor device, into bales.

The working unit 3 is driven by a mechanical drive train assembly 12, which can comprise a cardan shaft 11 that can be connected to the power take-off shaft of the tractor 2 in a rotary test and can be driven by the traction engine of the tractor 2, for example a diesel engine.

Said drive train assembly 12 comprises a unit transmission 6, which can be connected to the cardan shaft 11 and thus to the engine of the tractor 2 by a transmission input element 15, wherein said transmission input element 15 can be an input shaft of the unit transmission 6.

The transmission output element 14 of the unit transmission 6, which forms the output side or the output element of said unit transmission 6, can be a crankshaft 7, which drives the tamper 4 of the working unit 3 in a reciprocating manner via a connecting rod 8.

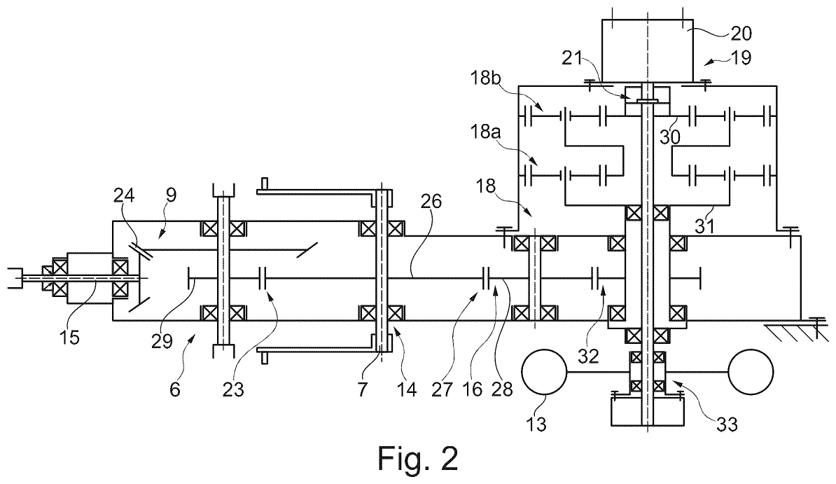

As shown in FIGS. 2 to 4, said unit transmission 6 can comprise one or more transmission gear stages between its transmission input and output elements 15, 14, which can be configured as transmission or reduction stages. In particular, the unit transmission 6 can comprise a bevel gear stage 24, which can drive the transmission output element 14, in particular said coupling shaft 7, directly or via an intermediate stage 25. The intermediate stage 25 can be a spur gear stage, for example, cf. FIGS. 2, 3 and 4.

In particular, the transmission output element 14 can have a gear wheel 26, preferably a spur gear, which can be configured in particular as a spur-toothed pinion, wherein said gear wheel 26 is seated on the crankshaft 7 and can be connected thereto in a rotationally fixed manner. Said gear wheel 26 can be driven by said intermediate stage 25 from the drive source 10, i.e. the drive train 9 connected to the power take-off shaft of the tractor 2 drives the output-side gear wheel 26 with the drive power of the tractor 2 or its power take-off shaft via the cardan shaft 11 and the unit transmission 6, which drives the crankshaft 7 in a rotary manner and thus drives the tamper 4 in a reciprocating manner.

As further shown in FIGS. 2, 3 and 4, a flywheel accumulator 13 is connected to the output side of the unit transmission 6 via a second drive train 17, wherein the second drive train 17 driving the flywheel accumulator 13 or, conversely, driven by it, can be connected in particular to the transmission output element 14 of the unit transmission 6 in the form of the gear wheel 26, so that the kinetic energy coming from the flywheel accumulator 13 can be applied directly to the crankshaft gear wheel 26 for smoothing load impacts of the tamper 4.

As shown in FIGS. 2 to 4, the second drive train 17 can be connected to the crankshaft gear wheel 26 of the unit transmission 6 via a spur gear stage 27.

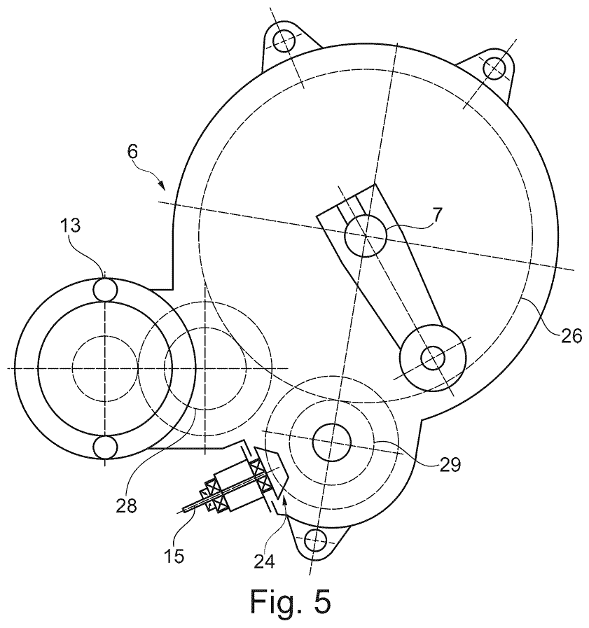

The spur gears 29 and 28 of the spur gear stages 25 and 27, via which said first and second drive trains 9 and 17 are connected to the output-side crankshaft gear wheel 26, can be in engagement with said gear wheel 26 in different circumferential sections, for example arranged on opposite sides of the gear wheel 26 or also arranged in adjacent sectors of the gear wheel 26, cf. FIG. 5, wherein an overall compact configuration of the unit transmission 6 can be achieved. For example, the two said spur gears 28, 29 can both be in engagement with a lower circumferential half of the crankshaft gear wheel 26, so that the unit transmission 6 and the flywheel accumulator 13 can be arranged overall below the crankshaft 7, cf. FIG. 5, which results in an overall compact and favorable design.

The flywheel accumulator 13 can be connected to the crankshaft gear wheel 26 via one or more further gear stages, or said second drive train 17 can have one or more gear stages, in particular in order to translate the speed of the crankshaft 7 into a higher flywheel accumulator speed.

As shown in FIG. 2, the second drive train 17 can, for example, have a two-stage or even multi-stage planetary gear 18, wherein the flywheel accumulator 13 can, for example, be connected to the sun wheel 30 of the second planetary gear stage 18b.

On the input side, the planetary gear 18, for example the planet carrier 31 of the first planetary stage 18a, can be connected to said crankshaft gear wheel 26 via an intermediate stage, for example a spur gear stage 32, cf. FIG. 2.

In order to be able to start up the flywheel accumulator 13 running at high speeds during operation, even if the drive source 10 can only provide a limited starting torque, a starting aid 19 can be provided for starting up the flywheel accumulator 13, wherein said starting aid 19 can have a start-up motor 20, for example an electric motor, wherein said start-up motor 20 can, for example, be connected to the sun wheel 30 of the second gear stage or can be in mesh with it in order to be able to drive the sun wheel shaft and thus the flywheel accumulator 13.

In order to be able to switch off the start-up motor 20 during the intended operation of the drive train assembly 12, the start-up motor 20 can be connected to the flywheel accumulator 13 via an overrunning freewheel 21, which takes the flywheel accumulator 13, in particular the sun wheel 30, with it when starting up, but on the other hand allows the start-up motor 20, for example the sun wheel 30, to rotate faster than the start-up motor 20 or can also rotate when the start-up motor 20 is stationary.

In order to avoid an overload in the drive train assembly 12, for example in the area of the planetary gear 18 and/or the intermediate stage 27 or 32, in the event of a blockage of the working unit 3, for example by a stone on the tamper 4 or also a blockage of another section of the drive train assembly 12, a safety slipping clutch 33 is preferably provided, which can preferably be arranged directly on the flywheel accumulator 13 or can separate all gear stages of the second drive train 17 from the flywheel accumulator 13. Said safety slipping clutch 33 forms an emergency slipping clutch, so to speak, which does not open or uncouple the flywheel accumulator 3 in the event of the intended load fluctuations or torque surges of the working unit 3, but only when a torque surge occurs which is above or or significantly above the intended load or torque surges which occur during normal operation of the working unit 3.

As shown in FIG. 2, said safety slipping clutch 33 can be provided, for example, between the flywheel accumulator 13 and the shaft of the sun wheel 30 or can be in engagement with the flywheel accumulator 13 on the one hand and the sun wheel 30 on the other hand.

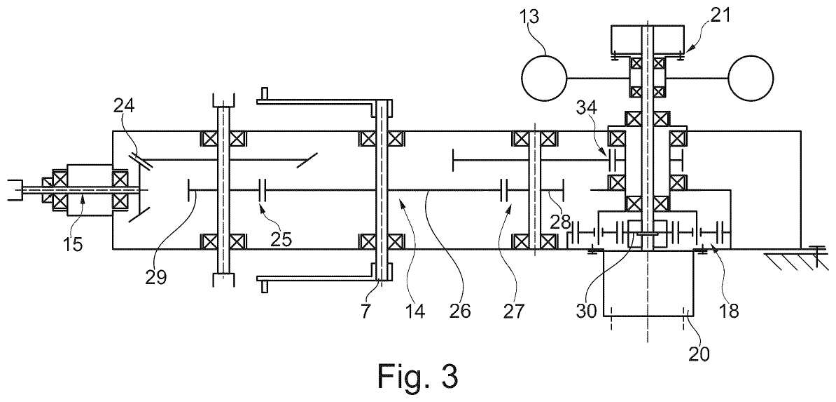

As shown in FIG. 3, the second drive train 17 can also have gear stages that are designed differently compared to FIG. 2, for example a single-stage planetary gear 18 and an additional intermediate stage between the planetary gear 18 and the connection to the crankshaft gear wheel 26, for example in the form of an additional spur gear stage 34, cf. FIG. 3.

Irrespective thereof, the start-up motor 20 can also be connected to the sun gear of the planetary gear 18 in the embodiment according to FIG. 3. Again independently of this, the flywheel accumulator 13 can also be connected to the sun gear 30 in order to rotate at its speed, wherein here again a safety slipping clutch 33 can be provided between the flywheel accumulator 13 and the gear stages of the second drive train 17, in particular between the flywheel accumulator 13 and the shaft of the sun gear 30, cf. FIG. 3.

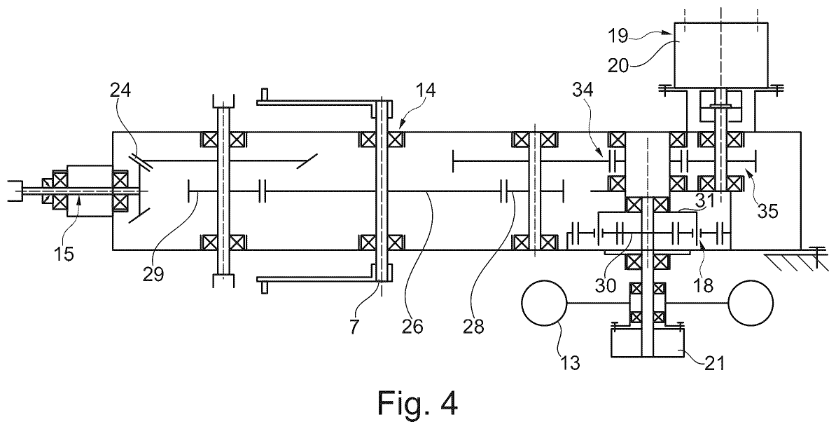

FIG. 4 shows a further example of the second drive train 17. Here, too, the second drive train 17 comprises a single-stage planetary gear 18, similar to the embodiment according to FIG. 3, as well as an intermediate stage, in particular in the form of a spur gear stage 34, between the planetary gear 18 and the connection to the crankshaft gear wheel 26. As shown in FIG. 4, the flywheel accumulator 13 can be connected to the sun gear 30 of the planetary gear 18 and can be engaged with the shaft of the sun gear 30 via a safety slipping clutch 33.

The start-up motor 20 also provided can be connected via an intermediate gear stage 35, for example in the form of a spur gear stage, wherein an overrunning freewheel 21 can also be provided here. As shown in FIG. 4, the start-up motor 20 can be connected to the planet carrier 31 of the planetary gear 18 via said intermediate gear stage 35 in order to drive said planet carrier 31 and thus be able to start up the flywheel accumulator 13.

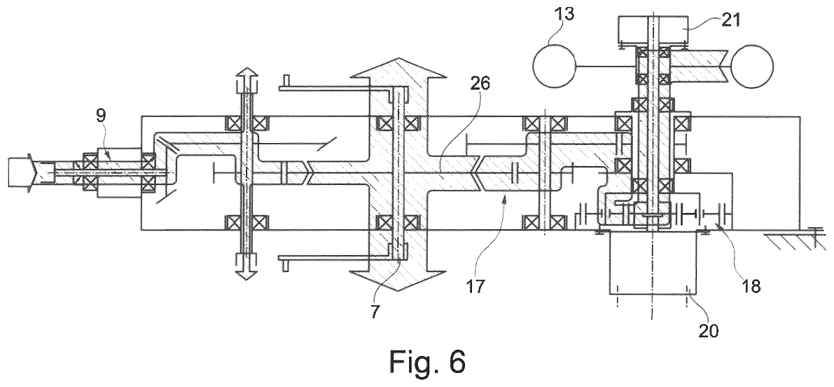

FIGS. 6 to 8 show the power flows occurring in various operating situations, with the hatched arrows representing the individual power flows or their branches. A thick arrow width or hatched area symbolizes a comparatively high transmitted power, while narrow arrows or narrow hatched areas symbolize relatively small power flows.

In this respect, FIG. 6 shows the power flows in the intended operation of the working unit 3 when a load impact of the tamper 4 is smoothed from the flywheel accumulator 13, i.e. a relatively high power flow is given from the flywheel accumulator 13 to the transmission output element 14, i.e. the crankshaft gear wheel 26, in order to smooth the load peak occurring at the tamper 4. As FIG. 6 further illustrates, the power flow coming from the tractor 2 via the first drive train 9 remains normal or relatively small compared to the power flow from the flywheel accumulator 13, i.e. the load peak occurring at the tamper 4 is not transferred to the first drive train 9.

As shown in FIG. 6, the power flows from the flywheel accumulator 13 and from the drive source 10 are summed up at the crankshaft gear wheel 26.

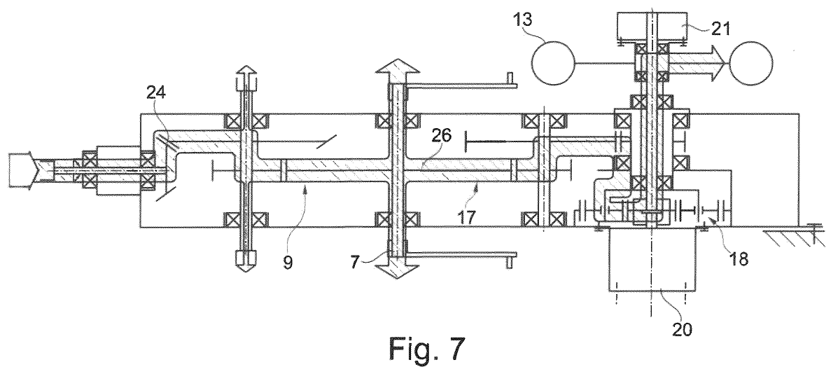

FIG. 7 also shows the power flows in the intended operation of the working unit 3, wherein an operating phase is shown in which power is only supplied from the drive source 10. The power supplied from the drive source 10 via the unit transmission 6 drives the crankshaft 7 and also drives the flywheel accumulator 13 via the second drive train 17. The power flow coming from the drive source 10 splits, so to speak, at the crankshaft gear wheel 26.

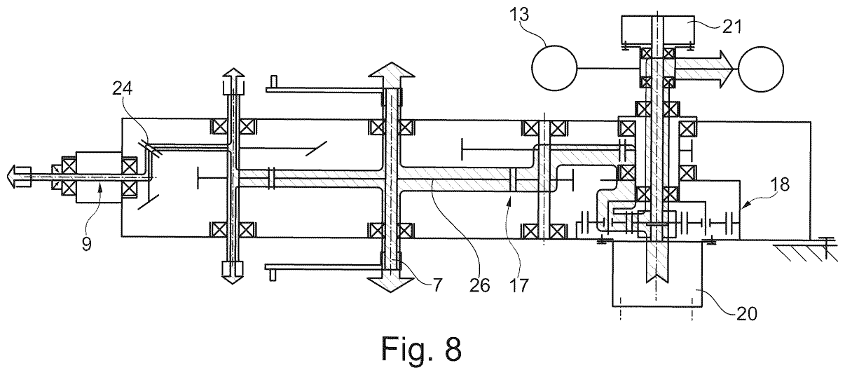

Finally, FIG. 8 shows the power flows during the starting process or starting up or running up the flywheel accumulator 13, wherein the start-up motor 20 feeds power into the planetary gear 18 and thereby runs up the flywheel accumulator 13. The first drive train 9 and thus the unit transmission 6 and the cardan shaft 11 are also dragged along load-free, so to speak, via the common crankshaft gear wheel 26.
The power take-off train can
allow the bevel gear set and the intermediate pinion to be smaller than before, because no more power and peak torques need to be transmitted from the flywheel;
enable cost-efficient production, as the bevel gear set is a machine element in the baler gearbox that strongly influences the value and can be dimensioned smaller.
The flywheel mass train can be
be connected to the gearing of the crankshaft sprocket by an additional pinion
the power from the flywheel train is transmitted via a second gear mesh from the crankshaft sprocket, which also receives the power from the power take-off train, wherein the crankshaft sprocket teeth can be made smaller by splitting the power;
increase the flywheel mass to higher speeds by means of a transmission ratio in the flywheel mass train and thus store high kinetic energy;
reduce the weight of the flywheel mass (Erot=½×Jo×2);
enable the flywheel mass and the baler to be raised via an auxiliary drive on the flywheel mass line in an advantageous manner with power sharing and bypassing the power take-off line;
avoid unnecessary slippage (overrunning the freewheel) when the synchronous speed between the power take-off speed and the flywheel speed is reached, with optional monitoring of the speeds up to the synchronous point;
bring the flywheel mass and the baler up to speed via a large slipping clutch on the drive;
the safety slipping clutch of the flywheel mass on the high-speed shaft can be made smaller;
enable power sharing via the flywheel.
The intermediate wheel can
provide more design space for the arrangement of the flywheel mass so that the crank arms do not collide;
have a double wheel for gear ratio adjustment (see FIGS. 3, 4, 6, 7, 8) and thus tuning to optimum rotational energy without, for example, changing the flywheel mass;
have a swelling tooth load due to a double wheel, thus higher torques can be transmitted in contrast to an alternating tooth load,
can be arranged in the direction of travel, depending on the space available (currently transverse to the direction of travel);
By using helical gears on the intermediate wheel, a flywheel axis can also be arranged perpendicularly, i.e. at right angles to the direction of travel or as required.
The safety slipping clutch can
be dimensioned in such a way that the moment of inertia is limited to a fixed value in the event of a blockage in the drive train or in the baler channel;
advantageously be arranged in the flywheel mass line, in the immediate vicinity of the flywheel mass, e.g. on the sun wheel shaft, as this wheel carries low torques;
alternatively be arranged on the web or ring gear of the planetary gear, as these have lower speeds;
for other reasons, such as accessibility to the clutch or limited space, also on the intermediate gear.
The auxiliary drive may have/be configured:
The drive can be hydraulic or electric.
The drive can be coupled to the sun gear shaft for low torques and high speeds.
Alternatively, the drive can be positioned on the web or ring gear for high torques and low speeds. A connection to the intermediate gear is also possible if this is required for technical reasons, e.g. favorable space conditions or advantageous accessibility.
The auxiliary drive is only used to start up the flywheel. This is equipped with an overrunning freewheel so that it can be switched off after the start-up process.
Alternatively, the auxiliary drive with the pinion can also be disengaged from the meshing similar to the “starter principle” in a motor vehicle, so that the pinion can be disengaged from the meshing of the mating gear and does not have to run idle (torque-free).
The planetary gear can be
be single-stage with improved oil guidance, possibly with a shift of transmission ratios to the intermediate gear; have a short axial design;
be two-stage, possibly with the use of a common ring gear;
be fully integrated into the housing of the baler drive and have a very short design so that the crank arms do not collide;
be partially integrated;
be flanged on the outside;
have an arrangement around the crankshaft wheel, in particular
optimized for oil management, low splash losses
designed for optimum bearing load on the crankshaft
be configured for a modular system, adapted to different tractor outputs and multiple arrangements;
have a multiple arrangement for engagement processes.
The flywheel/flywheel housing can be
external for good accessibility,
encapsulated for less air turbulence,
encapsulated and under negative pressure, wherein vacuum can be provided to reduce ventilation losses.

We claim:

1. A drive train assembly for driving a working unit with fluctuating power consumption from a drive source, the assembly comprising:
a unit transmission configured to convert a driving movement of the drive source into a working movement of the working unit and is connected by a transmission output element to the working unit and is connected by a transmission input element to the drive source, and
a flywheel accumulator for mitigating load impacts and/or power consumption fluctuations, wherein the flywheel accumulator is connected on the output side of the unit transmission to the drive train which extends from the unit transmission to the working unit.

2. The assembly of claim 1, wherein the flywheel accumulator is connected to the transmission output element and which is simultaneously connected the working unit.

3. The assembly of claim 1, wherein the transmission output element comprises a gear wheel configured to drive a crank leading to the working unit and, wherein the gear wheel is configured to engage with a connecting element for connecting the flywheel accumulator.

4. The assembly of claim 1, wherein two separate drive trains are together at the transmission output element, wherein a first drive train extends from the transmission output element through the unit transmission and via the gear stages thereof to the drive source and a second drive train extends from the transmission output element via the gear stages of the unit transmission to the flywheel accumulator.

5. The assembly of claim 4, wherein the first and second drive trains are each in face-to-face engagement with the transmission output element configured as a gear wheel and extend from the transmission output element on opposite sides.

6. The assembly of claim 5, wherein the first and second drive trains each comprise at least one or more transmission gear stages.

7. The assembly of claim 6, wherein the flywheel accumulator is connected to the transmission output element via at least one transmission gear stage so that the flywheel accumulator is configured to run at a higher speed than the transmission output element.

8. The assembly of claim 7, wherein the transmission gear stage comprises a planetary gear.

9. The assembly of claim 1, further comprising a starting aid for starting up the flywheel accumulator.

10. The assembly of claim 9, wherein the starting aid comprises a motor for supporting the starting up of the flywheel accumulator, and wherein the motor comprises a hydraulic motor or an electric motor.

11. The assembly of claim 10, further comprising an overrunning freewheel between the motor and the flywheel accumulator, wherein the overrunning freewheel is configured to permit relative rotation between the flywheel accumulator and the motor in a first direction of rotation and block a second direction of rotation, wherein the first direction is opposite to the second direction, and wherein the motor is configured to be switched off when the flywheel accumulator is rotating in the first direction.

12. The assembly to claim 1, wherein a shiftable gear comprises a shiftable planetary gear, and wherein the shifting gear is configured to act as a starting aid to support the starting of the flywheel accumulator.

13. The assembly of claim 1, wherein the unit transmission comprises a spur gear stage and an intermediate gear stage between the transmission input element and the transmission output element.

14. A working machine comprising the drive train assembly of claim 1.

15. The machine of claim 14 further comprising a working tool drivable in a reciprocating manner by a crankshaft.

16. The machine of claim 14, which is configured as an agricultural harvesting or soil tillage machine, in particular as a rectangular baler.

17. The machine of claim 14, wherein the machine is configured as an attachment device for attaching to a towing vehicle and wherein the working unit is coupleable to the drive source located on the towing vehicle via the drive train assembly.

18. The machine of claim 15, wherein the machine is configured as an attachment device for attaching to a towing vehicle and wherein the working unit is coupleable to the drive source located on the towing vehicle via the drive train assembly.

19. The machine of claim 16, wherein the machine is configured as an attachment device for attaching to a towing vehicle and wherein the working unit is coupleable to the drive source located on the towing vehicle via the drive train assembly.
